(19) United States
(12) Patent Application Publication
(10) Pub. No.: US 2015/0304572 A1
(43) Pub. Date: Oct. 22, 2015

(54) VIDEO PROCESSING DEVICE AND VIDEO PROCESSING METHOD

(71) Applicant: SHARP KABUSHIKI KAISHA, Osaka-shi, Osaka (JP)

(72) Inventors: Yuhji TANAKA, Osaka-shi (JP); Hiroshi MIKAMI, Osaka-shi (JP)

(21) Appl. No.: 14/440,406

(22) PCT Filed: Oct. 29, 2013
(86) PCT No.: PCT/JP2013/079202

§ 371 Date: May 4, 2015

(30) Foreign Application Priority Data
Nov. 5, 2012 (JP) 2012-243594

(51) Int. Cl. H04N 5/265; G09G 5/00; H04N 5/04

(52) U.S. Cl. CPC H04N 5/265; H04N 5/04; G09G 5/001; G09G 2360/12; G09G 2340/10

(57) ABSTRACT

A division circuit 11 divides input frames included in an input video Vi into plural pieces of partial data that are not superimposed with each other and outputs one piece of partial data for one input frame while switching selection of the partial data. A memory control circuit 14 writes the partial data output from the division circuit 11 in a frame memory 15, and reads a reconstruction frame that is configured by plural pieces of partial data based on a plurality of input frames that are different from each other and has a same size as the input frames from the frame memory 15. A composition circuit 19 composites the reconstruction frame read from the frame memory 15, and obtains an output video Vo that includes a composited frame. Thereby, an amount of access to the frame memory is reduced without deteriorating image quality significantly.

### TECHNICAL FIELD

The present invention relates to a video processing device and a video processing method, and in particular relates to a video processing device that composites and outputs a plurality of input videos and a video processing method.

### BACKGROUND ART

When a plurality of input videos are displayed on a display device such as a liquid crystal display device, a video processing device that composites and outputs the plurality of input videos is used. FIG. 10 is a block diagram showing a configuration of a conventional video processing device. In the video processing device shown in FIG. 10, input videos V1 to Vn are written in a frame memory 94 with an original size after processing by input control circuits 90, write buffers 91, a write arbitration circuit 92, and a memory control circuit 93. The input videos V1 to Vn written in the frame memory 94 are supplied to respective conversion circuits 97 via the memory control circuit 93, a read arbitration circuit 95 and read buffers 96. The conversion circuits 97 perform processing for converting a display position or a size of the input videos V1 to Vn. A composition circuit 98 composites videos output from the conversion circuits 97. The video obtained by the composition circuit 98 is output as an output video Vo via an output control circuit 99.

In the video processing device shown in FIG. 10, the input videos V1 to Vn are written in the frame memory 94 with the original size, and read from the frame memory 94 with the original size remained. Therefore, the video processing device shown in FIG. 10 has a problem that an amount of access to the frame memory 94 is increased. This problem becomes prominent when the number of the input videos is large.

The aforementioned problem is able to be solved by widening a band width of the frame memory 94. Specifically, considered are a method for increasing an amount of data which is able to be read and written in a single access and a method for increasing a speed of an access. However, the former method requires to increase the number of memories or the number of signal lines. Further, the latter method requires an expensive memory and a design of the memory control circuit becomes difficult. Therefore, the cost and power consumption of the video processing device are increased even when any of the methods is employed.

In relation to the invention of the present application, a following technology has been known conventionally. PTL 1 describes, as to an on-screen display system that stores plural pieces of video data in a frame memory for compositing, a method for, with respect to a part where two videos are superimposed in a display screen, reading only an overlay video from the frame memory and not reading a video behind the overlay video. PTL 2 described a method for reducing video data amount to store in a frame memory and enlarging the video read from the frame memory for displaying.

### CITATION LIST

### Patent Literature

PTL 1: Japanese Unexamined Patent Application Publication No. 10-177374

PTL 2: Japanese Unexamined Patent Application Publication No. 8-9343

### SUMMARY OF INVENTION

### Technical Problem

In the method described in PTL 1, however, when a plurality of videos are composited in a translucent manner, both of the overlay video and the video behind the overlay video need to be read from the frame memory. Therefore, this method has a problem that there is a case where an amount of access to the frame memory is not able to be reduced. Further, the method described in PTL 2 has a problem that a resolution is reduced and image quality is deteriorated because a video is reduced in a spatial direction.

Accordingly, the present invention aims to provide a video processing device and a video processing method capable of reducing an amount of access to a frame memory without deteriorating image quality significantly.

### Solution to Problem

A first aspect of the present invention is a video processing device that composites and outputs a plurality of input videos, including a frame memory; a division circuit that divides, as to one input video or more among the plurality of input videos, input frames included in the input video into plural pieces of partial data that are not superimposed with each other and outputs one piece of partial data for one input frame while switching selection of the partial data; a memory control circuit that writes the partial data output from the division circuit in the frame memory, and reads a reconstruction frame that is configured by plural pieces of partial data based on a plurality of input frames which are different from each other and has a same size as the input frames from the frame memory; and a composition circuit that composites the reconstruction frame read from the frame memory and obtains a video that includes the composited frame.

According to a second aspect of the present invention, in the first aspect of the present invention, the division circuit divides the input frame into data in an odd-numbered row and data in an even-numbered row.

According to a third aspect of the present invention, in the first aspect of the present invention, the division circuit divides the input frame into left-half data and right-half data.

According to a fourth aspect of the present invention, in the first aspect of the present invention, the division circuit divides the input frame into data in an odd-numbered column and data in an even-numbered column.

According to a fifth aspect of the present invention, in the first aspect of the present invention, the division circuit classifies the input frame into different partial data for each of a plurality of rows.

According to a sixth aspect of the present invention, in the first aspect of the present invention, the division circuit classifies the input frame into different partial data for each of a plurality of columns.

According to a seventh aspect of the present invention, in the first aspect of the present invention, the division circuit regards all input videos of the plurality of input videos as processing targets.

According to an eighth aspect of the present invention, in the first aspect of the present invention, the division circuit regards a part of the input video of the plurality of input videos as a processing target, the memory control circuit, as to a residual input video of the plurality of input videos, writes an input frame included in the input video as it is in the frame memory and reads the input frame written in the frame memory, and the composition circuit composites the input frame and the reconstruction frame read from the frame memory and obtains a video that includes the composited frame.

A ninth aspect of the present invention is a video processing method for compositing a plurality of input videos by using a frame memory, including a step of dividing, as to one input video or more among the plurality of input videos, input frames included in the input video into plural pieces of partial data that are not superimposed with each other and outputting one piece of partial data as to one input frame while switching selection of the partial data; a step of writing the partial data that is output in the frame memory; a step of reading a reconstruction frame that is configured by plural pieces of partial data based on a plurality of input frames which are different from each other and has a same size as the input frames from the frame memory; and a step of compositing the reconstruction frame read from the frame memory and obtains a video that includes the composited frame.

### Advantageous Effects of Invention

According to the first or ninth aspect of the present invention, by writing a part of the input frames in the frame memory and reading the reconstruction frame having a same size as the input frames from the frame memory, it is possible to composite the video having a same size as the input video while reducing an amount of data to be written in the frame memory. Accordingly, it is possible to reduce an amount of access to the frame memory without deteriorating image quality significantly. Further, it is possible to perform complicated display with little increase in a size of the frame memory, the number of circuits and power consumption.

According to the second aspect of the present invention, by writing any one of the data in the odd-numbered row and the data in the even-numbered row as to one input frame included in the input video in the frame memory, it is possible to reduce an amount of data to be written in the frame memory as to this input video to a half.

According to the third aspect of the present invention, by writing any one of the left-half data and the right-half data as to one input frame included in the input video in the frame memory, it is possible to reduce an amount of data to be written in the frame memory as to this input video to a half.

According to the fourth aspect of the present invention, by writing any one of the data in the odd-numbered column and the data in the even-numbered column as to one input frame included in the input video in the frame memory, it is possible to reduce an amount of data to be written in the frame memory as to this input video to a half.

According to the fifth aspect of the present invention, by classifying the input frames included in the input video into partial data for each of a plurality of rows and writing one piece of partial data for one input frame in the frame memory, it is possible to reduce an amount of data to be written in the frame memory as to this input video to a half or less.

According to the sixth aspect of the present invention, by classifying the input frames included in the input video into partial data for each of a plurality of columns and writing one piece of partial data for one input frame in the frame memory, it is possible to reduce an amount of data to be written in the frame memory as to this input video to a half or less.

According to the seventh aspect of the present invention, by performing processing for writing a part of the input frames in the frame memory for all the input videos, it is possible to reduce an amount of data to be written in the frame memory as to all the input videos.

According to the eighth aspect of the present invention, by performing processing for writing a part of the input frames in the frame memory for a part of the input video, it is possible to reduce an amount of data to be written in the frame memory as to the part of the input video and prevent deterioration of image quality as to the residual input video.

### BRIEF DESCRIPTION OF DRAWINGS

FIG. 1 is a block diagram showing a configuration of a video processing device according to a first embodiment of the present invention.

FIG. 2 is a view showing an example of processing by the video processing device according to the first embodiment of the present invention.

FIG. 3 is a timing chart of the video processing device according to the first embodiment of the present invention.

FIG. 4 is a timing chart of a conventional video processing device.

FIG. 5 is a view showing division of input frames in a video processing device according to a second embodiment of the present invention.

FIG. 6 is a timing chart of the video processing device according to the second embodiment of the present invention.

FIG. 7 is a view showing division of input frames in a video processing device according to a third embodiment of the present invention.

FIG. 8 is a timing chart of the video processing device according to the third embodiment of the present invention.

FIG. 9 is a block diagram showing a configuration of a video processing device according to a fourth embodiment of the present invention.

FIG. 10 is a block diagram showing a configuration of a conventional video processing device.

### DESCRIPTION OF EMBODIMENTS

### First Embodiment

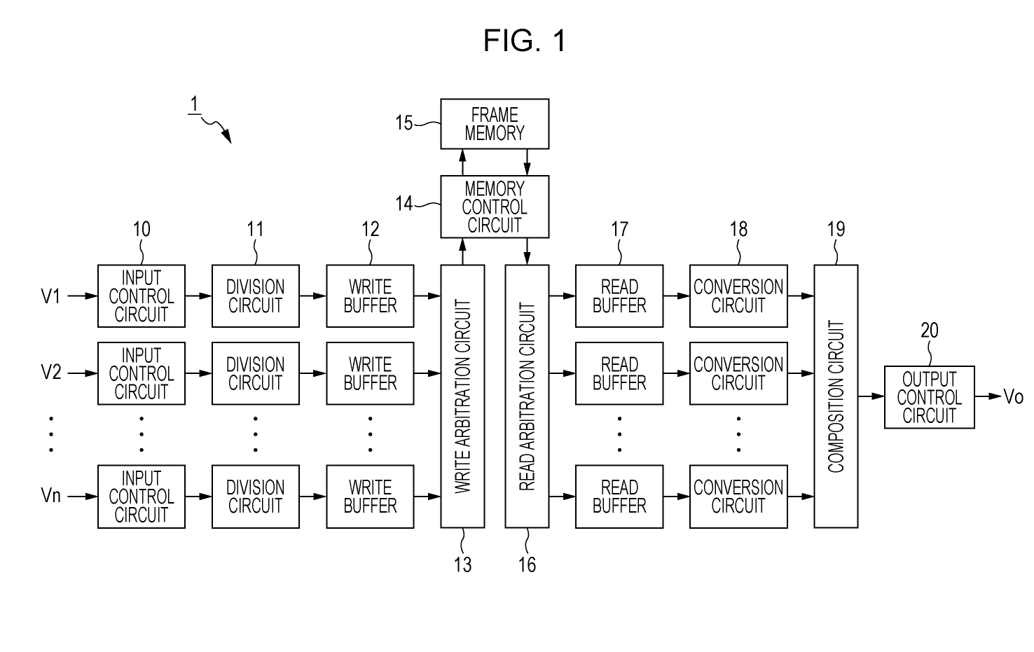

FIG. 1 is a block diagram showing a configuration of a video processing device according to a first embodiment of the present invention. A video processing device 1 shown in FIG. 1 includes n (n is an integer of 2 or more) input control circuits 10, n division circuits 11, n write buffers 12, a write arbitration circuit 13, a memory control circuit 14, a frame memory 15, a read arbitration circuit 16, n read buffers 17, n conversion circuits 18, a composition circuit 19 and an output control circuit 20.

To the video processing device 1, n input videos V1 to Vn are input. The video processing device 1 includes the n input control circuits 10, the n division circuits 11, the n write buffers 12, the n read buffers 17 and the n conversion circuits 18, correspondingly to the n input videos V1 to Vn. A circuit corresponding to an i-th (i is an integer from 1 to n) input video Vi is referred to as an i-th circuit below. The video processing device 1 composites the input videos V1 to Vn and outputs an output video Vo. The input videos V1 to Vn and the output video Vo include a plurality of frames (still images) which are consecutive in a time direction. Note that, the input videos V1 to Vn and the output video Vo may have a same or different size.

An i-th input control circuit 10 extracts a vertical synchronizing signal, a horizontal synchronizing signal, a signal indicating an effective range of a video, video data and the like from the input video Vi, and sequentially outputs frames included in the input video Vi (hereinafter, referred to as input frames) to the i-th division circuit 11.

The i-th division circuit 11 divides the input frames into m (m is an integer of 2 or more) pieces of partial data that are not superimposed with each other, and outputs one piece of partial data for one input frame while switching selection of the partial data. For example, in the case of m=2, the i-th division circuit 11 divides the input frames into two pieces of partial data, and outputs one of partial data for an odd-numbered frame and outputs the other partial data for an even-numbered frame.

The i-th division circuit 11 writes the partial data based on the input video Vi in the unit of a row in the i-th write buffer 12. When data for a single row is written, the i-th write buffer 12 outputs a write request to the write arbitration circuit 13. The write arbitration circuit 13 determines which of write requests output from the n write buffers 12 to respond, and outputs the write request to the memory control circuit 14. The memory control circuit 14 writes the data of a single row which is written in any one of the write buffers 12 in the frame memory 15 in accordance with the write request output from the write arbitration circuit 13. By repeating this processing, one piece of partial data is written in the frame memory 15.

By performing the processing for writing one piece of partial data in the frame memory 15 for m input frames and combining the m pieces of partial data in the frame memory 15, it is possible to configure a frame that is configured by the m pieces of partial data based on the m input frames which are different from each other and has a same size as the input frames (hereinafter, referred to as a reconstruction frame). In the example of m=2 above, by writing one of the two pieces of partial data in the frame memory 15 in the case of the odd-numbered frame and writing the other of the two pieces of partial data in the frame memory 15 in the case of the even-numbered frame, and combining the two pieces of partial data in the frame memory 15, the reconstruction frame is able to be configured. The i-th conversion circuit 18 performs processing not for the input frames included in the input video Vi but for the reconstruction frame based on the input video Vi.

The i-th conversion circuit 18 reads the reconstruction frame based on the input video Vi in the unit of a row from the i-th read buffer 17. When data for a single row is read, the i-th read buffer 17 outputs a read request to the read arbitration circuit 16. The read arbitration circuit 16 determines which of read requests output from the n read buffers 17 to respond, and outputs the read request to the memory control circuit 14. The memory control circuit 14 writes the data for a single row which is read from the frame memory 15 in any of the read buffers 17 in accordance with the read request output from the read arbitration circuit 16. By repeating this processing, one reconstruction frame is read from the frame memory 15.

The i-th conversion circuit 18 performs processing for converting a display position or a size for the reconstruction frame based on the input video Vi. The composition circuit 19 composites the converted reconstruction frames which are output from the n conversion circuits 18 and obtains a video which includes the composited frames. The output control circuit 20 outputs the video obtained by the composition circuit 19 as the output video Vo in synchronization with a timing of a device which is connected to a next stage of the video processing device 1 (for example, display device).

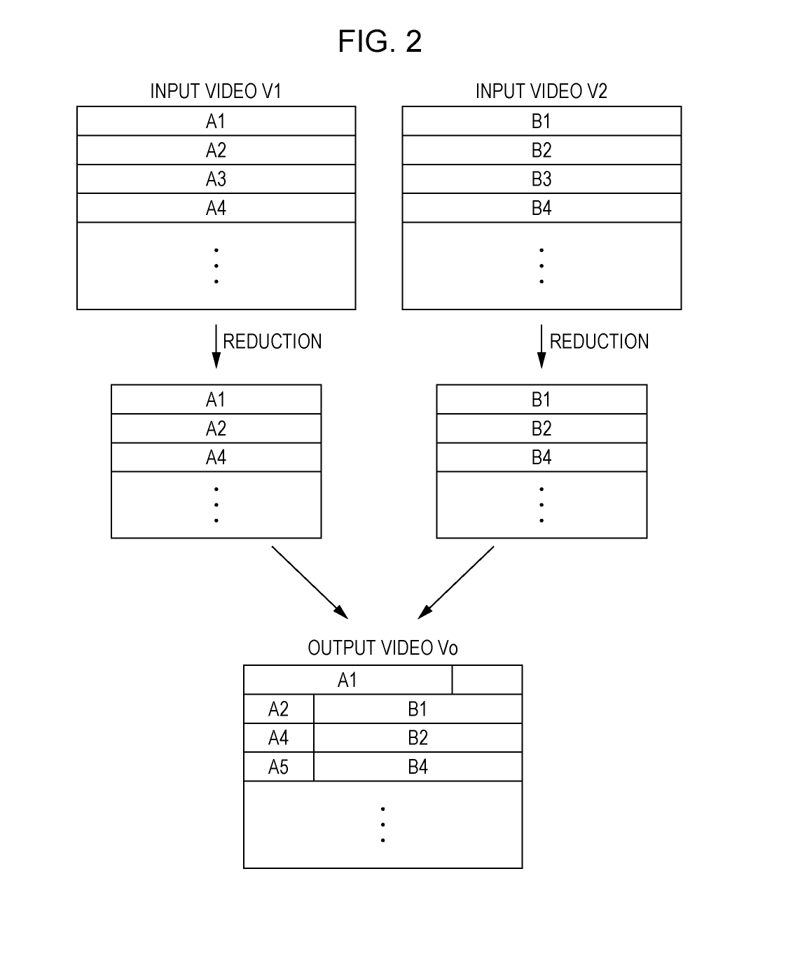

Description will be given below for a case where m=n=2 and the video processing device 1 reduces and composites two input videos V1 and V2 (refer to FIG. 2). In FIG. 2, A1, A2, . . . represent data for a single row of input frames included in the input video V1 (or input frames after reduction), and B1, B2, . . . represent data for a single row of input frames included in the input video V2 (or input frames after reduction).

In the present embodiment, the i-th division circuit 11 divides the input frames included in the input video Vi into data in an odd-numbered row and data in an even-numbered row, and outputs one of the data in the odd-numbered row and the data in the even-numbered row for an odd-numbered frame and outputs the other of the data in the odd-numbered row and the data in the even-numbered frame for an even-numbered frame.

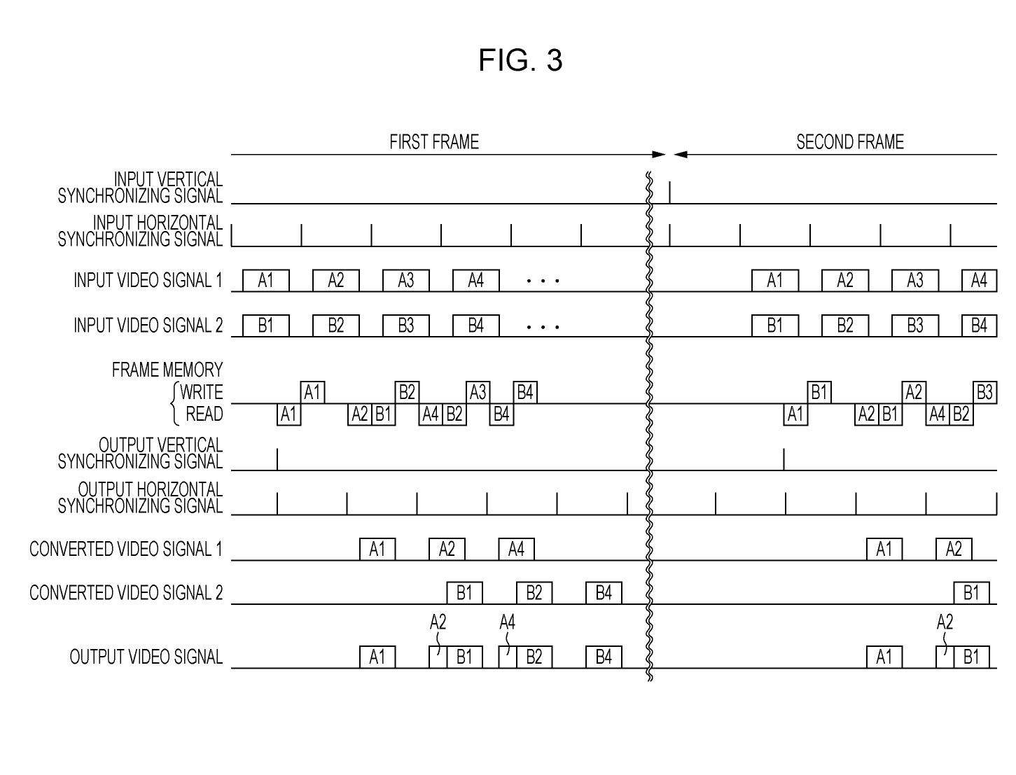

FIG. 3 is a timing chart of the video processing device according to the present embodiment. The first division circuit 11 outputs the data in the odd-numbered row for the odd-numbered frame and outputs the data in the even-numbered row for the even-numbered frame. The second division circuit 11 outputs the data in the even-numbered row for the odd-numbered frame and outputs the data in the odd-numbered row for the even-numbered frame. Accordingly, for a first frame, data A1, A3, . . . in the odd-numbered row of the input video V1 and data B2, B4, . . . in the even-numbered row of the input video V2 are written in the frame memory 15. For a second frame, data A2, A4, . . . in the even-numbered row of the input video V1 and data B1, B3, . . . in the odd-numbered row of the input video V2 are written in the frame memory 15.

The first conversion circuit 18 reads data A1, A2, A4, . . . in each row from the frame memory 15 both for the odd-numbered frame and for the even-numbered frame in order to obtain the reconstruction frame based on the first input video V1. The second conversion circuit 18 reads data B1, B2, B4, . . . in each row from the frame memory 15 both for the odd-numbered frame and for the even-numbered frame in order to obtain the reconstruction frame based on the second input video V2.

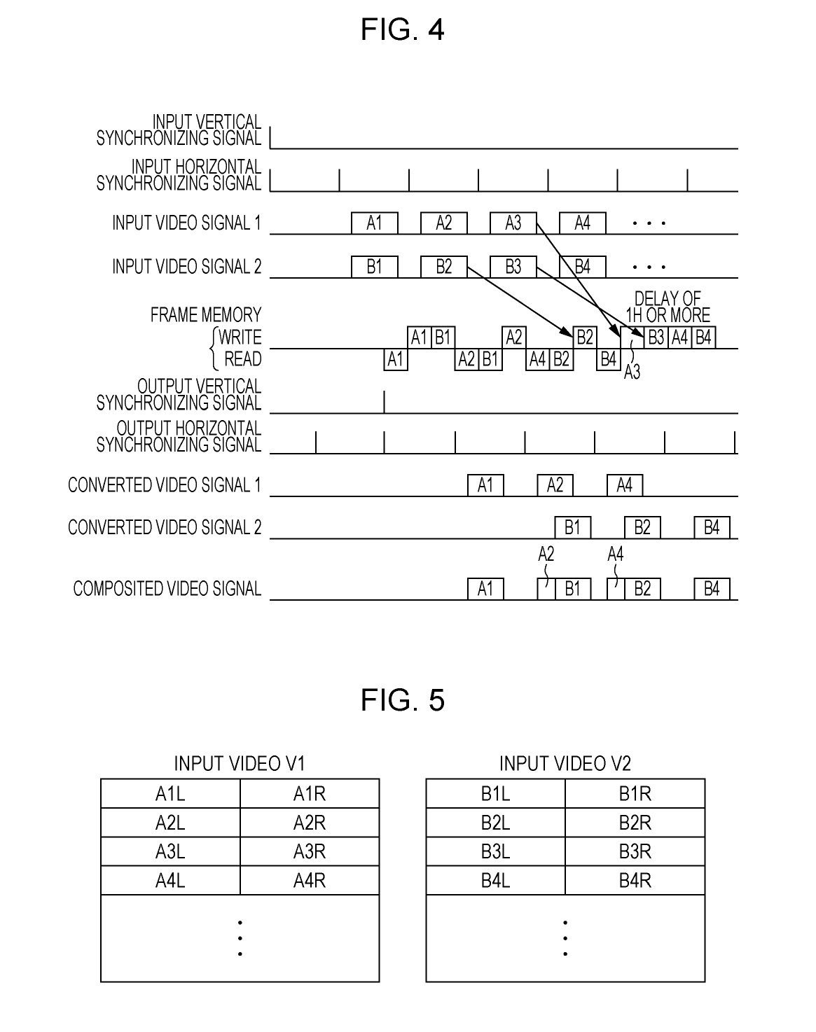

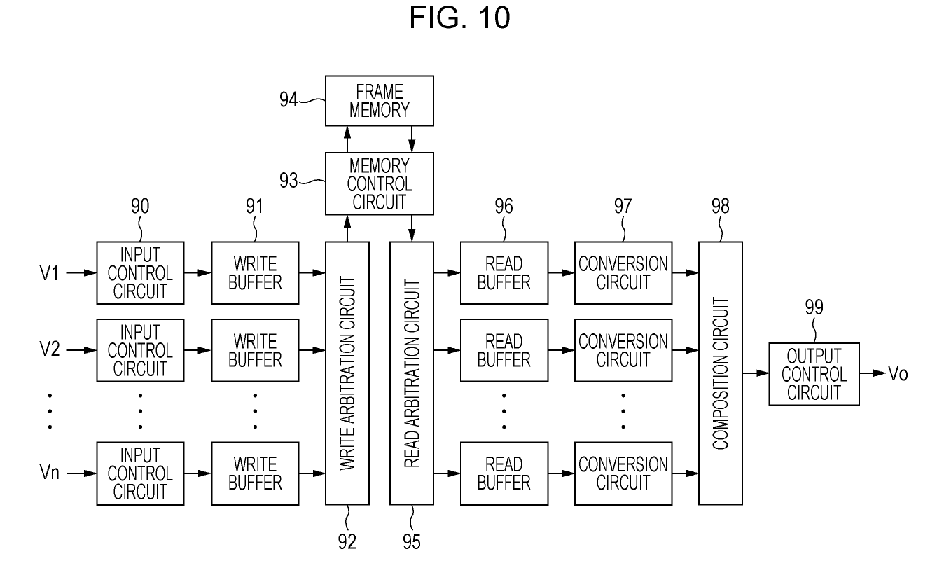

Description will be given below for an effect of the video processing device according to the present embodiment by comparing FIG. 3 and FIG. 4. FIG. 4 is a timing chart of a conventional video processing device shown in FIG. 10. The conventional video processing device reduces and composites two input videos V1 and V2.

In the timing chart shown in FIG. 4, in a period from when data for a single row is input in the video processing device to when this data is written in a frame memory 94, a delay of one horizontal period (1H) or more is caused in some cases. If the write is delayed for one horizontal period or more when a write buffer 91 is able to accumulate only data for two rows, the data written in the write buffer 91 is overwritten.

As a method for solving this problem, considered are a method for widening a band width of the frame memory 94 and a method for increasing a size of the write buffer 91. However, the former method has a problem that a high-speed memory which is expensive and has large power consumption is required. The latter method has a problem that the cost and the power consumption of the write buffer 91 are increased.

In the video processing device 1 according to the present embodiment, the division circuit 11 that divides input frames included in the input video Vi into plural pieces of partial data that are not superimposed with each other (here, data in an odd-numbered row and data in an even-numbered row) and outputs one piece of partial data for one input frame while switching selection of the partial data is included between the input control circuit 10 and the write buffer 12. The memory control circuit 14 writes the partial data output from the division circuit 11 in the frame memory 15 and reads a reconstruction frame that is configured by plural pieces of partial data based on a plurality of input frames which are different from each other and has a same size as the input frames from the frame memory 15.

In this manner, by writing a part of the input frames in the frame memory 15 and reading the reconstruction frame having the same size as the input frames from the frame memory 15, it is possible to composite videos having the same size as the input video while reducing an amount of data to be written in the frame memory 15. Accordingly, it is possible to reduce an amount of access to the frame memory 15 without deteriorating image quality significantly. Further, it is possible to perform various compositing processing (for example, processing for compositing a plurality of videos in a translucent manner) with little increase in a size of the frame memory 15, the number of circuits and power consumption.

In the present embodiment, the division circuit 11 divides input frames into data in an odd-numbered row and data in an even-numbered row. In this manner, by writing either one of the data in the odd-numbered row or the data in the even-numbered row as to one input frame included in an input video in the frame memory 15, it is possible to reduce an amount of data to be written in the frame memory 15 as to this input video to a half. Moreover, in the present embodiment, the division circuit 11 regards all input videos of the n input videos V1 to Vn as processing targets. In this manner, by performing the processing for writing a part of the input frames in the frame memory 15 for all input videos, it is possible to reduce an amount of data to be written in the frame memory 15 as to all of the input videos.

### Second Embodiment

A video processing device according to a second embodiment of the present invention has the same configuration as that of the video processing device according to the first embodiment (FIG. 1). Description will be given below for differences from the first embodiment.

FIG. 5 is a view showing division of input frames in the video processing device according to the second embodiment of the present invention. In FIG. 5, L represents a left half of data for a single row and R represents a right half of data for a single row. In the present embodiment, the i-th division circuit 11 divides input frames included in the input video Vi into left-half data and right-half data. Further, the i-th division circuit 11 outputs one of the left-half data and the right-half data for an odd-numbered frame and outputs the other of the left-half data and the right-half data for an even-numbered frame.

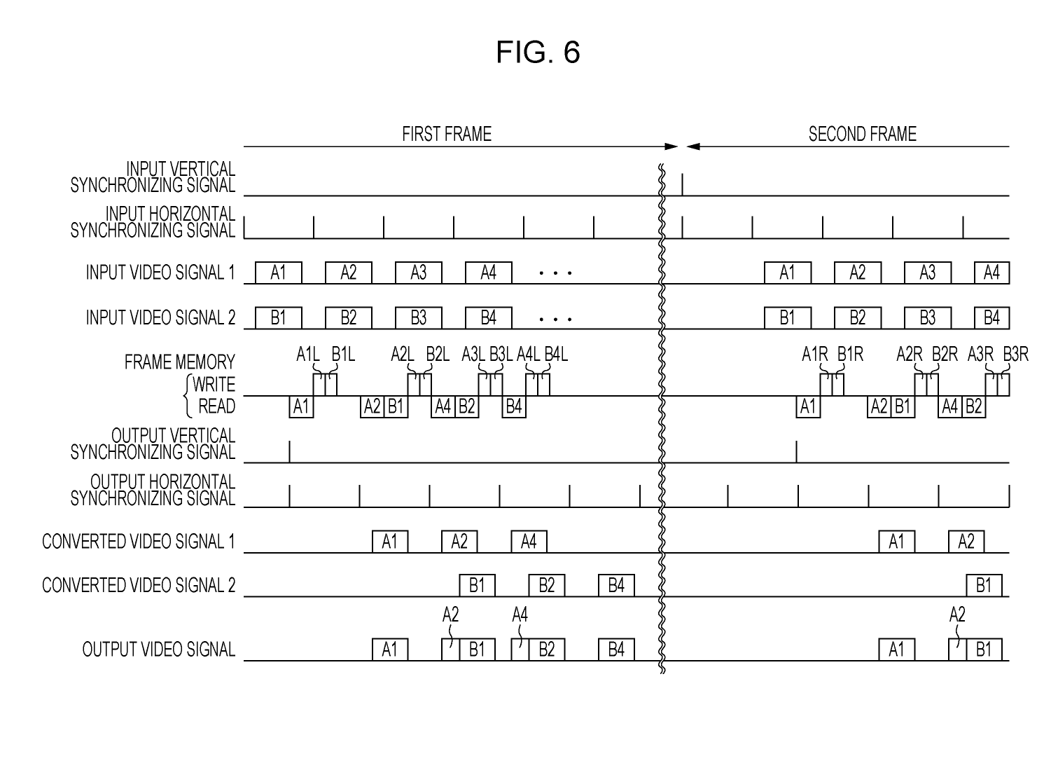

FIG. 6 is a timing chart of the video processing device according to the present embodiment. The first and second division circuits 11 output the left-half data for the odd-numbered frame and output the right-half data for the even-numbered frame. Accordingly, for a first frame, left-half data A1L, A2L, . . . based on the input video V1 and left-half data B1L, B2L, . . . based on the input video V2 are written in the frame memory 15. For a second frame, right-half data A1R, A2R, . . . based on the input video V1 and right-half data B1R, B2R, . . . based on the input video V2 are written in the frame memory 15. The first and second conversion circuits 18 operate in the same manner as the first embodiment.

According to the video processing device of the present embodiment, by writing any one of the left-half data and the right-half data as to one input frame included in an input video in the frame memory 15, it is possible to reduce an amount of data to be written in the frame memory 15 as to this input video to a half. Thereby, the same effect as the first embodiment is able to be achieved.

### Third Embodiment

A video processing device according to a third embodiment of the present invention has the same configuration as that of the video processing device according to the first embodiment (FIG. 1). Description will be given below for differences from the first embodiment.

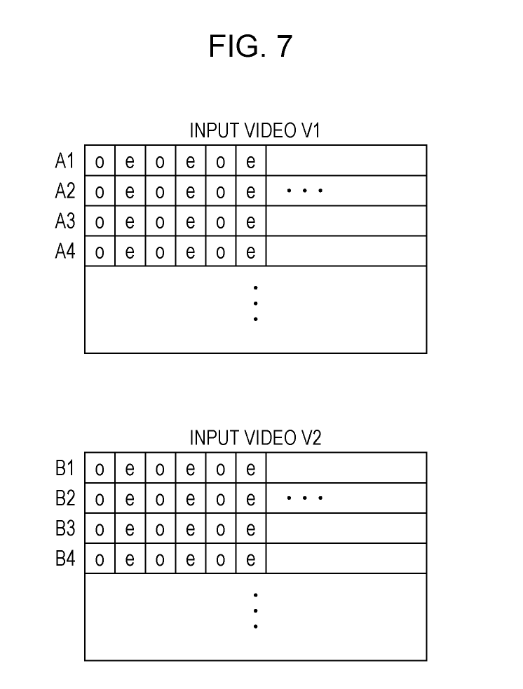

FIG. 7 is a view showing division of input frames in the video processing device according to the third embodiment of the present invention. In FIG. 7, o represents data in an odd-numbered column and e represents data in an even-numbered column. In the present embodiment, the i-th division circuit 11 divides input frames included in the input video Vi into data in an odd-numbered column and data in an even-numbered column. Further, the i-th division circuit 11 outputs one of the data in the odd-numbered column and the data in the even-numbered column for an odd-numbered frame and outputs the other of the data in the odd-numbered column and the data in the even-numbered column for an even-numbered frame.

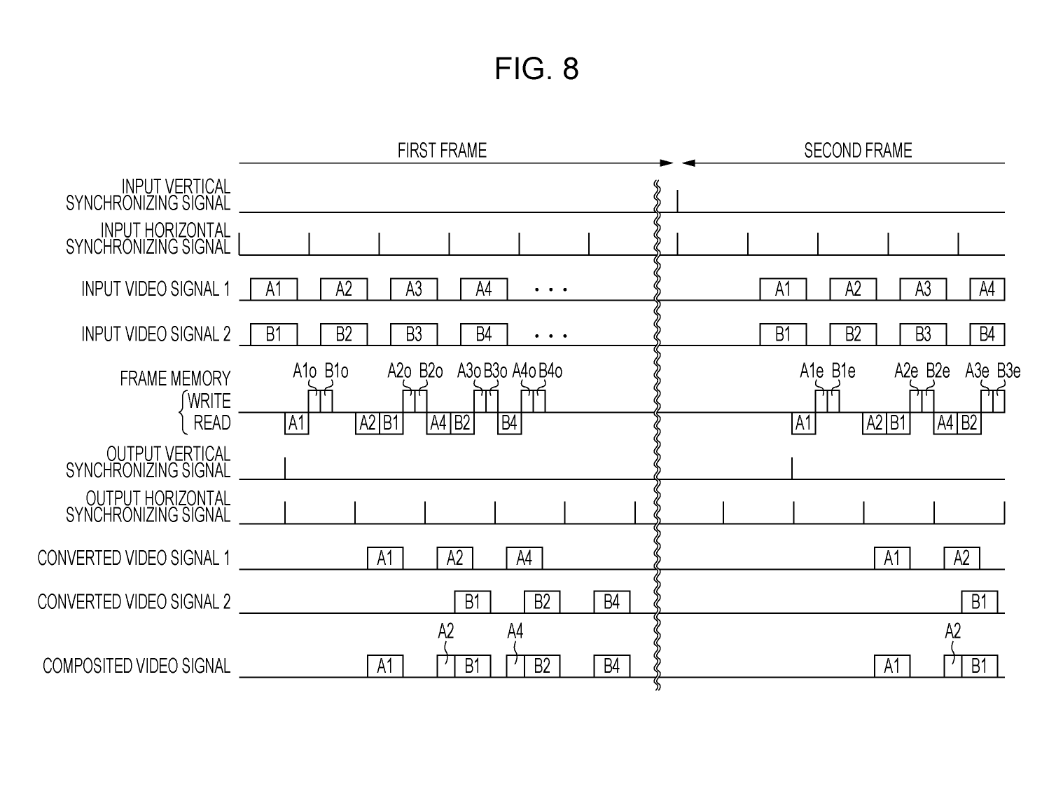

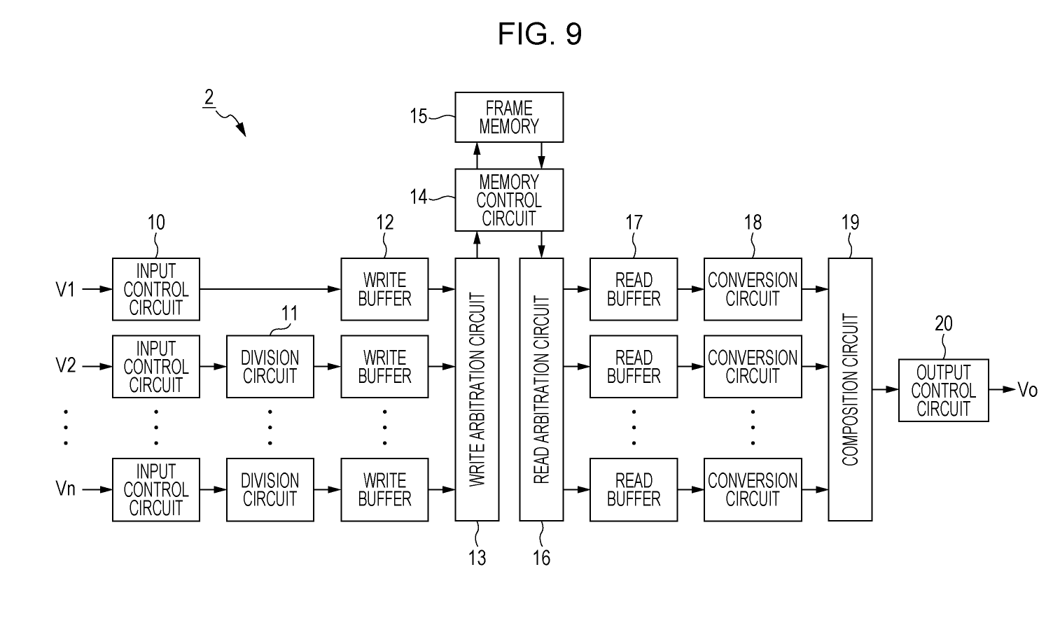

FIG. 8 is a timing chart of the video processing device according to the present embodiment. The first and second division circuits 11 output the data in the odd-numbered column for the odd-numbered frame and output the data in the even-numbered column for the even-numbered frame.

Accordingly, in the case of a first frame, data in the odd-numbered column A1o, A2o, . . . based on the input video V1 and data in the odd-numbered column B1o, B2o, . . . based on the input video V2 are written in the frame memory 15. In the case of a second frame, data in the even-numbered column A1e, A2e, . . . based on the input video V1 and data in the even-numbered column B1e, B2e, . . . based on the input video V2 are written in the frame memory 15. The first and second conversion circuits 18 operate in the same manner as the first embodiment.

According to the video processing device of the present embodiment, by writing any one of the data in the odd-numbered column and the data in the even-numbered column as to one input frame included in an input video in the frame memory 15, it is possible to reduce an amount of data to be written in the frame memory 15 as to this input video to a half. Thereby, the same effect as the first embodiment is able to be achieved.

### Fourth Embodiment

FIG. 9 is a block diagram showing a configuration of a video processing device according to a fourth embodiment of the present invention. A video processing device 2 shown in FIG. 9 is obtained by deleting the first division circuit 11 from the video processing device according to the first embodiment (FIG. 1). Same reference numerals are assigned, among constituent elements of the present embodiment, to same elements as those of the first embodiment and description thereof is omitted.

The video processing device 2 according to the present embodiment does not include the division circuit 11 corresponding to the input video V1. The memory control circuit 14 writes an input frame included in the input video V1 as it is in the frame memory 15, and reads the input frame written in the frame memory 15. Further, the memory control circuit 14 writes partial data which is output from the (n−1) division circuit 11 in the frame memory 15 and reads a reconstruction frame based on input videos V2 to Vn from the frame memory 15. The composition circuit 19 composites the input frame and the reconstruction frame read from the frame memory 15 and obtains a video including the composited frame.

The video processing device 1 according to the first to third embodiments includes the n division circuits 11 correspondingly to all input videos of the n input videos V1 to Vn. Therefore, when the input video Vi is a moving image, the reconstruction frame based on the input video Vi is discontinuous or blurs near a border of division in some cases.

On the contrary, the video processing device 2 according to the present embodiment includes the (n−1) division circuit 11 correspondingly to the input videos V2 to Vn as a part of the n input videos V1 to Vn. By performing processing for writing a part of the input frames in the frame memory 15 in this manner as to the input videos V2 to Vn, it is possible to reduce an amount of data to be written in the frame memory 15 as to the input videos V2 to Vn. Further, it is possible to prevent deterioration of image quality for the input video V1 which is a residual input video.

Note that, various modified examples are able to be configured as to the video processing devices according to the embodiments of the present invention. For example, in the video processing devices according to the first to fourth embodiments, the i-th division circuit 11 may classify input frames included in the input video Vi into different partial data for each of a plurality of rows. For example, the i-th division circuit 11 may divide the input frames into partial data which includes a first row, a second row, a fifth row, a sixth row, . . . , and partial data which includes a third row, a fourth row, a seventh row, an eighth row, . . . . In this manner, by classifying the input frames included in the input video into partial data for each of a plurality of rows and writing one piece of the partial data as to one input frame in the frame memory 15, it is possible to reduce an amount of data to be written in the frame memory 15 as to this input video to a half or less.

Moreover, in the video processing devices according to the first to fourth embodiments, the i-th division circuit 11 may classify input frames included in the input video Vi into different partial data for each of a plurality of columns. For example, the i-th division circuit 11 may divide the input frames into partial data which includes a first column, a second column, a fifth column, a sixth column, . . . , and partial data which includes a third column, a fourth column, a seventh column, an eighth column, . . . . In this manner, by classifying the input frames included in the input video into partial data for each of a plurality of columns and writing one piece of the partial data as to one input frame in the frame memory 15, it is possible to reduce an amount of data to be written in the frame memory 15 as to this input video to a half or less.

Moreover, in the video processing devices according to the first to fourth embodiments, the i-th division circuit 11 may divide input frames included in the input video Vi into three or more pieces of partial data. Further, the video processing device according to the fourth embodiment may include the one or more and (n−2) or less of division circuits 11.

As described above, according to the video processing device and a video processing method of the present invention, by writing a part of input frames in a frame memory and reading a reconstruction frame having a same size as the input frames from the frame memory, it is possible to composite a video having the same size as an input video while reducing an amount of data to be written in the frame memory. Accordingly, it is possible to reduce an amount of access to the frame memory without deteriorating image quality significantly.

### (Additional Remarks)

As the video processing device and the video processing method of the present invention, following configurations are considered.

### (Additional Remark 1)

A video processing device that composites and outputs a plurality of input videos, including:

a frame memory;

a division circuit that divides, as to one input video or more among the plurality of input videos, input frames included in the input video into plural pieces of partial data that are not superimposed with each other and outputs one piece of partial data for one input frame while switching selection of the partial data;

a memory control circuit that writes the partial data output from the division circuit in the frame memory, and reads a reconstruction frame that is configured by plural pieces of partial data based on a plurality of input frames which are different from each other and has a same size as the input frames from the frame memory; and

a composition circuit that composites the reconstruction frame read from the frame memory and obtains a video that includes the composited frame.

With such a configuration, by writing a part of the input frames in the frame memory and reading the reconstruction frame having a same size as the input frames from the frame memory, it is possible to composite the video having a same size as the input video while reducing an amount of data to be written in the frame memory. Accordingly, it is possible to reduce an amount of access to the frame memory without deteriorating image quality significantly. Further, it is possible to perform complicated display with little increase in a size of the frame memory, the number of circuits and power consumption.

### (Additional Remark 2)

The video processing device according to the additional remark 1, wherein the division circuit divides the input frame into data in an odd-numbered row and data in an even-numbered row.

With such a configuration, by writing any one of the data in the odd-numbered row and the data in the even-numbered row as to one input frame included in the input video in the frame memory, it is possible to reduce an amount of data to be written in the frame memory as to this input video to a half.

### (Additional Remark 3)

The video processing device according to the additional remark 1, wherein the division circuit divides the input frame into left-half data and right-half data.

With such a configuration, by writing any one of the left-half data and the right-half data as to one input frame included in the input video in the frame memory, it is possible to reduce an amount of data to be written in the frame memory as to this input video to a half.

### (Additional Remark 4)

The video processing device according to the additional remark 1, wherein the division circuit divides the input frame into data in an odd-numbered column and data in an even-numbered column.

With such a configuration, by writing any one of the data in the odd-numbered column and the data in the even-numbered column as to one input frame included in the input video in the frame memory, it is possible to reduce an amount of data to be written in the frame memory as to this input video to a half.

(Additional remark 5)

The video processing device according to the additional remark 1, wherein the division circuit classifies the input frame into different partial data for each of a plurality of rows.

With such a configuration, by classifying the input frames included in the input video into partial data for each of a plurality of rows and writing one piece of partial data for one input frame in the frame memory, it is possible to reduce an amount of data to be written in the frame memory as to this input video to a half or less.

### (Additional Remark 6)

The video processing device according to the additional remark 1, wherein the division circuit classifies the input frame into different partial data for each of a plurality of columns.

With such a configuration, by classifying the input frames included in the input video into partial data for each of a plurality of columns and writing one piece of partial data for one input frame in the frame memory, it is possible to reduce an amount of data to be written in the frame memory as to this input video to a half or less.

### (Additional Remark 7)

The video processing device according to the additional remark 1, wherein the division circuit regards all input videos of the plurality of input videos as processing targets.

With such a configuration, by performing processing for writing a part of the input frames in the frame memory for all the input videos, it is possible to reduce an amount of data to be written in the frame memory as to all the input videos.

### (Additional Remark 8)

The video processing device according to the additional remark 1, wherein

the division circuit regards a part of the input video of the plurality of input videos as a processing target,

the memory control circuit, as to a residual input video of the plurality of input videos, writes an input frame included in the input video as it is in the frame memory and reads the input frame written in the frame memory, and

the composition circuit composites the input frame and the reconstruction frame read from the frame memory and obtains a video that includes the composited frame.

With such a configuration, by performing processing for writing a part of the input frames in the frame memory for a part of the input video, it is possible to reduce an amount of data to be written in the frame memory as to the part of the input video and prevent deterioration of image quality as to the residual input video.

### (Additional Remark 9)

A video processing method for compositing a plurality of input videos by using a frame memory, including:

a step of dividing, as to one input video or more among the plurality of input videos, input frames included in the input video into plural pieces of partial data that are not superimposed with each other and outputting one piece of partial data as to one input frame while switching selection of the partial data;

a step of writing the partial data that is output in the frame memory;

a step of reading a reconstruction frame that is configured by plural pieces of partial data based on a plurality of input frames which are different from each other and has a same size as the input frames from the frame memory; and

a step of compositing the reconstruction frame read from the frame memory and obtains a video that includes the composited frame.

With such a configuration, by writing a part of the input frames in the frame memory and reading the reconstruction frame having a same size as the input frames from the frame memory, it is possible to composite the video having a same size as the input video while reducing an amount of data to be written in the frame memory. Accordingly, it is possible to reduce an amount of access to the frame memory without deteriorating image quality significantly. Further, it is possible to perform complicated display with little increase in a size of the frame memory, the number of circuits and power consumption.

### INDUSTRIAL APPLICABILITY

The video processing device and the video processing method of the present invention have a characteristic that an amount of access to the frame memory is able to be reduced without deteriorating image quality significantly, and are therefore applicable when a plurality of input videos are displayed on various display devices such as a liquid crystal display device.

### REFERENCE SIGNS LIST

1, 2 video processing device
10 input control circuit
11 division circuit
12 write buffer
13 write arbitration circuit
14 memory control circuit
15 frame memory
16 read arbitration circuit
17 read buffer
18 conversion circuit
19 composition circuit
20 output control circuit

1. A video processing device that composites and outputs a plurality of input videos, the video processing device comprising:
a frame memory;
a division circuit that divides, as to one input video or more among the plurality of input videos, input frames included in the input video into plural pieces of partial data that are not superimposed with each other and outputs one piece of partial data for one input frame while switching selection of the partial data;
a memory control circuit that writes the partial data output from the division circuit in the frame memory, and reads a reconstruction frame that is configured by plural pieces of partial data based on a plurality of input frames which are different from each other and has a same size as the input frames from the frame memory; and
a composition circuit that composites the reconstruction frame read from the frame memory and obtains a video that includes a composited frame.

2. The video processing device according to claim 1, wherein the division circuit divides the input frame into data in an odd-numbered row and data in an even-numbered row.

3. The video processing device according to claim 1, wherein the division circuit divides the input frame into left-half data and right-half data.

4. The video processing device according to claim 1, wherein the division circuit divides the input frame into data in an odd-numbered column and data in an even-numbered column.

5. The video processing device according to claim 1, wherein the division circuit classifies the input frame into different partial data for each of a plurality of rows.

6. The video processing device according to claim 1, wherein the division circuit classifies the input frame into different partial data for each of a plurality of columns.

7. The video processing device according to claim 1, wherein the division circuit regards all input videos of the plurality of input videos as processing targets.

8. The video processing device according to claim 1, wherein
the division circuit regards a part of the input video of the plurality of input videos as a processing target,
the memory control circuit, as to a residual input video of the plurality of input videos, writes an input frame included in the input video as it is in the frame memory and reads the input frame written in the frame memory, and
the composition circuit composites the input frame and the reconstruction frame read from the frame memory and obtains a video that includes the composited frame.

9. A video processing method for compositing a plurality of input videos by using a frame memory, the video processing method comprising:
a step of dividing, as to one input video or more among the plurality of input videos, input frames included in the input video into plural pieces of partial data that are not superimposed with each other and outputting one piece of partial data as to one input frame while switching selection of the partial data;
a step of writing the partial data that is output in the frame memory;
a step of reading a reconstruction frame that is configured by plural pieces of partial data based on a plurality of input frames which are different from each other and has a same size as the input frames from the frame memory; and
a step of compositing the reconstruction frame read from the frame memory and obtains a video that includes a composited frame.
